(19) United States
(12) Patent Application Publication
(10) Pub. No.: US 2007/0129857 A1
(43) Pub. Date: Jun. 7, 2007

(54) SYSTEM AND A METHOD FOR UPDATING THE APPROACH PATH IN THE FLIGHT PLAN OF AN AIRCRAFT DURING THE APPROACH PHASE TO A LANDING RUNWAY COMPRISING AN ALIGNMENT POINT

(75) Inventor: Stephanie FORTIER, Cugnaux (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 11/560,631

(22) Filed: Nov. 16, 2006

(30) Foreign Application Priority Data
Nov. 16, 2005 (FR) 05 11618

(51) Int. Cl. G01C 23/00

(52) U.S. Cl. 701/16; 701/3

(57) ABSTRACT

This invention relates to a system and a method for updating the approach path in the flight plan of an aircraft during the approach phase to a landing runway comprising an alignment point. The method includes a preselection phase for preselecting landing runways of the destination airport including their approach procedures that would be suitable for the landing of the aircraft type, a phase to determine all the approach paths corresponding to the runways and to the preselected procedures, a phase during the flight to select the active runway and the active procedure, a phase during the flight to update the route in the flight plan to join as soon as possible the approach path corresponding to the active runway and to the active procedure, starting from the current position of the aircraft on the route of the flight plan and before the alignment point with the runway.

This invention relates to a system and a method for updating the approach path in the flight plan of an aircraft during the approach phase to a landing runway, the runway comprising an alignment point. It is particularly applicable to the field of avionics.

A flight plan is a detailed description of the path to be followed by an aircraft for a flight scheduled in advance. In particular, it comprises a route that is a chronological sequence of waypoints described by their position, their altitude and the time they are overflown. The aircraft will go through the waypoints if it respects its flight plan perfectly, thus the flight plan forms a valuable aide for ground control personnel and also for onboard piloting personnel to anticipate aircraft movements and to assure optimum safety. The flight plan is usually managed by a system referred to as the <<Flight Management System>>, which will be referred to as FMS in the following, which makes the flight plan available to other onboard systems. In particular, the automatic pilot system uses the flight plan provided by the FMS to perform its functions and thus control the aircraft throughout the flight, either to assist or to replace the pilot.

During the approach phase, in other words during the period immediately before landing, it is particularly likely that the flight plan as known to the FMS may not be followed. The approach phase takes place in dense traffic areas such as airport areas to which a large number of flights continuously converge. Due to temporary or long term unavailability of the expected landing runway, which for example might be assigned to landing of another flight, an approach controller frequently notifies the pilot about a change to the landing runway at a late stage. However, note that this notification about a runway change must take place before the alignment point with the runway, this point being the point beyond which the aircraft heading must remain perfectly in line with the runway. Only the pilot has the authority to divert the aircraft beyond the alignment point, and in this case he must follow a procedure usually referred to as a <<missed approach>>, to escape from the runway along a dedicated secure path on which there is no risk of collision in such an overloaded airport area.

The runway change notified by a controller is necessarily accompanied by a change in the approach procedure, which describes how the runway must be approached in terms of approach path and in terms of landing assistance equipment that can be used. The crew should make the choice of the approach procedure, taking account of the capabilities of the aircraft and of its landing assistance equipment operational at that time. In any case, the flight plan provided by the FMScan no longer be used as such by other onboard systems, particularly the automatic pilot system, because it does not take account of the new runway and the new approach procedure.

One existing solution to this problem of changing the landing runway at the last minute consists simply of performing the latest approach maneuvers without following any flight plan, simply applying visual flight rules and then landing manually. The information provided by the FMS is ignored and the automatic pilot system is deactivated. The permanent radio dialogue between the approach controller and the pilot assures minimum safety conditions. The controller guides the pilot in his heading, altitude and speed changes up to the alignment point with the landing runway. The pilot terminates the maneuver by landing the aircraft using onboard instruments without the assistance of any ground equipment, and particularly without assistance of the very efficient and widely used Instrument Landing System (ILS). The ILS consists essentially of an emitting beacon at the end of the runway, the beacon emitting a signal at a given frequency. If this frequency is known to onboard systems, then beyond the runway alignment point, all that is necessary is to maintain the heading in the direction from which the received signal power is highest to be sure of remaining in line with the runway. If there is no up-to-date flight plan, onboard systems do not know the transmission frequency of such an ILS beacon on the runway on which the controller has aligned the aircraft. And if the pilot uses a wrong frequency entered manually, he could lead his aircraft towards an ILS beacon of another runway, which could have catastrophic consequences. Finally, without an up-to-date flight plan, onboard systems do not know the missed approach procedure in force on the runway. If a bad manual landing maneuver is performed, the pilot should escape from the runway by applying visual flight rules once again. The constant increase in traffic makes such a procedure without ILS and without missed approach procedure more and more difficult to achieve and less and less safe. In the long term, a controller and a pilot alone will no longer be able to accept responsibility for this type of procedure, which is much too risky.

Another solution is to use a <<secondary>> flight plan in addition to the normal or <<active>> flight plan. The active flight plan is the one used by the FMS and taken as a reference by onboard systems at all times. The secondary flight plan is initially a copy of the active flight plan and allows the piloting personnel to manually modify the flight plan to take account of the characteristics of the new runway and of the new approach procedure, while permanently assuring the active flight plan, in other words without disturbing systems that use it as a reference. Considering the characteristics of the new runway and of the new approach procedure takes a non-negligible time and in particular requires successive adjustments. Therefore, these successive adjustments are made on the secondary flight plan, which is not a reference for onboard systems. Once adjustments to the secondary flight plan have been terminated, the secondary flight plan becomes the active flight plan and vice-versa, upon an order by the piloting personnel. Then the FMS notifies onboard systems about the update to the flight plan. This update consists essentially of modifying the last waypoints in the flight plan to give the best reflection of the approach path corresponding to the new runway and the new approach procedure.

In this operational context, such a modification to the flight plan is not risk-free. The approach phase is a critical step in the flight, during which onboard personnel need to concentrate on their work, even if there isn't a late change to the landing runway. The stress level is maximum, and the trickiest landing maneuvers have to be performed in the most highly frequented zones. These are also the zones in which the systems are most likely to trigger warnings and therefore needlessly attract the attention of piloting personnel. Management of the runway change by successive adjustments to the secondary flight plan during this crisis phase introduces a non-negligible risk factor. Furthermore, a runway change may be notified so late that frequently the crew cannot avoid a visual flight step, since they were unable to finalize a transition path between the active flight plan and the secondary flight plan containing the new approach path. The new active flight plan then has a discontinuity in its sequence of waypoints, so that visual flight is necessary to join the new approach path after the active flight plan has been updated. Even if the services of the FMS can still be used, this solution is risky due to the extra work that it introduces and it does not eliminate visual flight. Therefore, it cannot assure optimum safety.

In particular, the purpose of the invention is to enable the use of the FMS continuously after notification of the landing runway, even at a very late stage, without using a visual flight phase.

To achieve this, the invention relates to a method for updating the approach path in the flight plan of an aircraft during the approach phase to a landing runway comprising an alignment point. Its first step is a phase to preselect landing runways of the destination aerodrome including their approach procedures that would be suitable for landing of the aircraft type. Then, it also includes a phase to determine all approach paths corresponding to the runways and to the procedures that were preselected. Finally, it includes a phase during the flight to select the active runway and the active procedure, immediately followed by a phase to update the route of the flight plan to join as soon as possiblethe approach path corresponding to the active runway and to the active procedure, starting from the current position of the aircraft on the route of the flight plan and before the alignment point with the runway.

Advantageously, only available runways on the destination airport can be chosen during the runway and procedure preselection phase (1), and then only the procedures in force on a selected runway can be chosen.

Another purpose of the invention is a system for updating the approach path in the flight plan of an aircraft during the approach phase to a landing runway comprising an alignment point, used to implement the method described above. It comprises a module to preselect landing runways of the destination aerodrome including their approach procedures that would be suitable for landing of the aircraft type. It also includes a module to construct approach paths corresponding to the preselected runways and procedures. Finally, it comprises a module to select the active runway and the active procedure, and a module to calculate a path for joining the active approach path as soon as possible, starting from the current position of the aircraft on the route of the flight plan and before the alignment point with the runway.

Advantageously, the module to preselect the runways and procedures can propose only the runways that are available on the destination airport, and then only the procedures in force on a selected runway.

In one embodiment, the system may also comprise a graphic module to display the approach paths.

Another important advantage of the invention is that it enables a systematically assisted landing maneuver. Onboard systems, and particularly the FMS, always have useful information about the runway actually used. They are capable of providing the pilot with this information on request or depending on their relevance in some situations. By virtue of this information, onboard systems are also capable of triggering warnings and of recommending corrective measures or even of efficiently assisting the pilot in the case of the automatic piloting system. Furthermore, the use made of onboard systems is always adapted to available systems on the runway, for example authorizing systematic use of the ILS as soon as it is available. Therefore the landing maneuver is much less stressful for the pilot, his onboard systems providing him with information about the missed approach procedure in force on the runway at all times. Flight safety during this critical phase is very much improved.

Other characteristics and advantages of the invention will become clear after reading the following description with reference to the attached drawings that show:

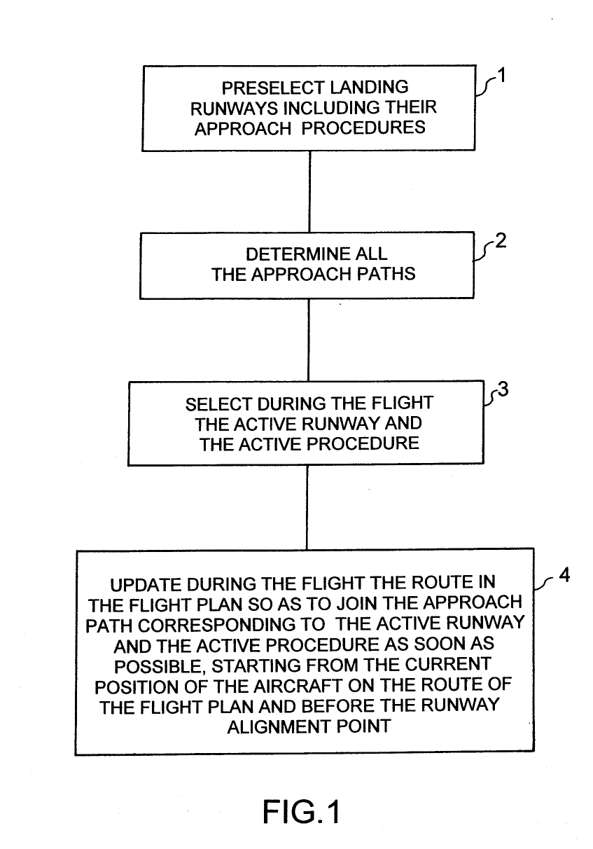

FIG. 1, a block diagram illustrating the successive phases of the method according to the invention;

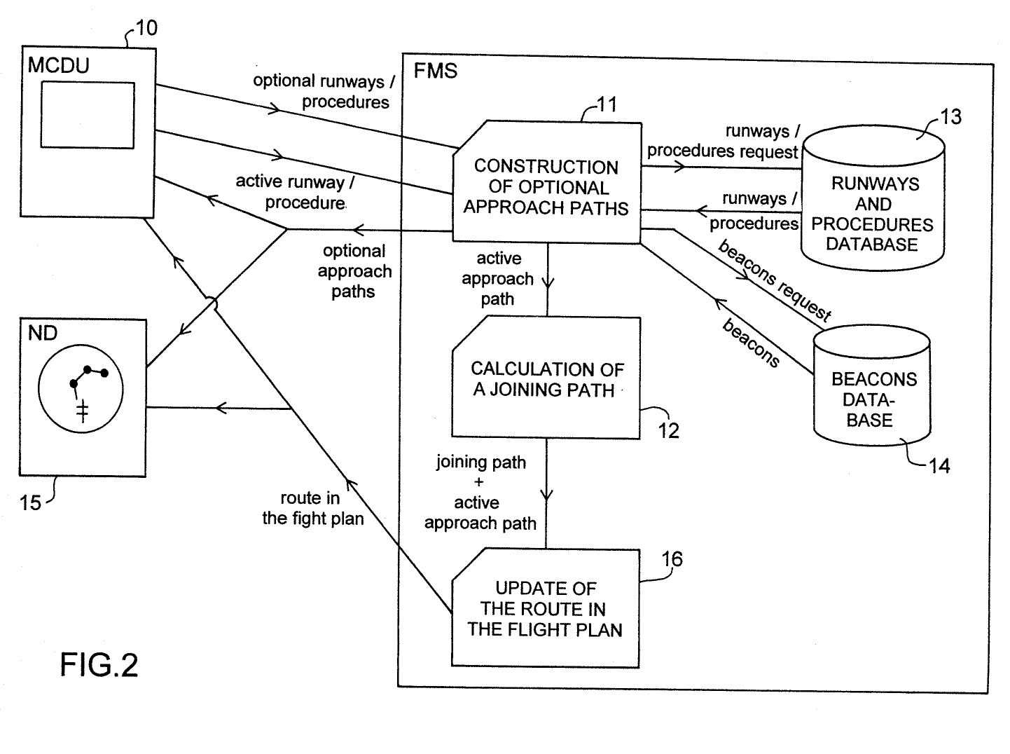

FIG. 2, a block diagram illustrating an example of an FMS architecture implementing the method according to the invention.

FIG. 1 illustrates the possible phases of the method according to the invention in a block diagram.

Firstly, it comprises a first phase 1 to preselect landing runways on the destination aerodrome with their approach procedures that would be suitable for landing this type of aircraft. The piloting personnel need to choose alternate runways to the runway scheduled in the active flight plan, among the runways on the destination airport. One of the approach procedures is also chosen for each chosen runway. In one advanced embodiment based on the man-machine interface, the pilot may advantageously only receive proposals for runways on the destination airport, and then for example only procedures available for the runway that he has selected. A runway could be chosen several times with a different approach procedure each time. The piloting personnel make the choice considering the capabilities of the aircraft and its landing assistance equipment.

This phase takes place well before the approach phase, at a time at which the piloting personnel are not at their maximum work load. This is a key point of the invention because the objective is to anticipate a runway change. For example, it may be done immediately after all operations and verifications related to take off are terminated, after the aircraft has left the airport zone with high traffic density and when it has just entered the cruising phase. Thus the work load of piloting personnel is much lower and they can concentrate on the task to preselect alternate runways and approach procedures without neglecting any other task and without increasing their stress level. This new task could last for a large proportion of the cruising phase, provided that it is terminated before the beginning of the approach phase and particularly before an approach controller, who is the only person likely to notify that the expected runway is unavailable, has taken the flight under his control. This phase could also be performed before take-off and even before the FMS has received the flight plan, because all that is necessary is to know the flight destination and the aircraft that will be used. By anticipating a possible change to the landing runway, the method according to the invention smoothes the work load of the personnel by reducing the work load during the approach phase. The stress peak inherent to the approach phase is attenuated, correspondingly improving the ability of piloting personnel to deal with other contingencies during this difficult phase. Flight safety is very much improved.

The method according to the invention then comprises a subsequent phase 2 to determine all possible approach paths as a function of runway-procedure pairs previously selected in phase 1. There is an approach path for each of these pairs, in other words a sequence of waypoints described by their position and their altitude and terminating by the alignment point with the landing runway. These waypoints are obtained by breaking down the approach procedure into aeronautical beacons and then into waypoints, known using aeronautical databases. One approach path will have been generated after this phase for each pair selected by the piloting personnel, all paths for the same runway terminating at the same alignment point. In a highly automated embodiment, this phase 2 may not require any action by onboard personnel, who can even display all the different approach path options that are compatible with the aircraft and its equipment. Once again, this phase must be terminated before the beginning of the approach phase and could be envisaged even before take-off.

The next in-flight phase 3 in the method according to the invention is then to select the runway-procedure pair that will actually be used to land the aircraft, among those selected in phase 1. It is then said that this runway and this procedure are active. When an approach controller notifies that the runway contained in the flight plan is unavailable, he also notifies the new runway to be used. The pilot then simply needs to select which of the pairs selected in phase 1 contains the new runway and appears to him to be most appropriate for the operational conditions at that time. It would be possible to imagine that a failure occurring during flight would prevent the use of some landing assistance equipment and therefore exclude some approach procedures even though they had been selected in phase 1. In one sophisticated embodiment based on a man-machine interface, the pilot may for example use a pointing system to select the pair in the list of pairs selected in phase 1, and then only the approach path corresponding to this pair remains displayed. It is then said that this approach path is active. This selection operation, although it is manual and takes place during the approach phase, is sufficiently simple so that it does not introduce any extra work or increase the stress level of onboard personnel, even at the very last minute. It is the only manual intervention related to the invention that takes place during the approach phase.

Finally, the method according to the invention comprises a next in-flight phase 4 to update the route in the flight plan so as to move into the active approach path as soon as possible, starting from the current position of the aircraft on the route of the flight planand before the alignment point with the runway. This phase is started immediately at the end of the previous phase 3, in other words as soon as the pilot has actually selected the runway and the approach procedure that he will actually use. Furthermore, the objective is to calculate a path in three dimensions so as to bring the current position of the aircraft on the route of the flight plan at a position on the active approach path that is necessarily before the alignment point with the runway, otherwise the aircraft would not be facing the landing runway at the right approach angles. Furthermore, another objective is to calculate this path to join the active approach path as soon as possible, in other words by minimizing the flight distance and time, so as to limit in-flight maneuvers outside aeronautical routes. This is the best way of limiting the risks of collisions that are high in an airport area with very dense traffic. The joining path and the active approach path are inserted at the end of the route in the flight plan, which is the purpose of updating it. This does not introduce any discontinuity in the flight plan, and it means that the FMS can be used continuously without deactivating the automatic pilot system. There is no visual flight. The ILS system is used if it is available on the runway, since its emission frequency is known with certainty by the FMS, therefore there is no longer any manual landing. The missed approach procedure in force on the runway is also systematically known, so that the runway can be evacuated under optimum safety conditions if necessary.

FIG. 2 illustrates in a block diagram an example of an FMS architecture implementing the method according to the invention.

It comprises a <<Multi Purpose Control Display Unit>> type module 10 that will be called the MCDU in the following. This module is used to preselect landing runways on the destination aerodrome with their approach procedures suitable for landing this type of aircraft. An MCDU is an integrated screen and keyboard device that is fairly widely used in avionics. Its main characteristic is to offer very generic display and input services for alphanumeric characters. Thus, it can easily be adapted to various new applications and particularly to the use of the invention. In the example embodiment in FIG. 2, the MCDU 10 enables piloting personnel to introduce optional runways and approach procedures, in other words suitable for landing the aircraft. For example, according to one elementary embodiment, the pilot could read a list of runways and approach procedures on paper and could enter them character by character using the MCDU keyboard 10. He simultaneously checks his input on the screen of this MCDU 10. But advantageously and using storage means of the landing runways and approach procedures as a database 13, for example the MCDU 10 can also be used firstly to view the list of runways on the destination airport using the screen, and secondly select which runways are suitable by using only the arrow keys on the keyboard. Also advantageously and according to the same operating method, the MCDU 10 can then be used to view the list of approach procedures in force on each selected runway, and then to select the procedure that is most suitable for the aircraft.

It should be noted that the MCDU is only used as an example, and any other display and input device with sufficient configuration capacities could be used.

The runways and optional approach procedures selected on the MCDU 10 are received by a function 11 of the FMS to construct the corresponding optional approach paths. The function 11 uses a database type of means 14 for the storage of aeronautical beacons, and transforms each of the selected approach procedures into a sequence of waypoints. These sequences of waypoints are described as being sequences of position-altitude pairs, and form optional approach paths. All optional approach paths for a given runway converge towards its alignment point. The approach paths are sent to the MCDU 10 for alphanumeric display in a list. Advantageously, a <<Navigational Display>> type module 15 that will subsequently be referred to as the ND, can also receive optional paths for simultaneous graphic display. An ND is a round screen device fairly widely used in avionics, providing graphic display services. It is already frequently used to display paths in the form of sequences of waypoints, for example the route of the flight plan as a whole, and is therefore very easily adaptable to implementation of the invention. An ND is usually coupled to an MCDU and graphically displays the same type of data as the data displayed alphanumerically on the MCDU. This is the case for the MCDU and the ND in the example embodiment in FIG. 2. This coupled operation assures that information items available to piloting personnel are consistent and relevant with respect to each other depending on the active display mode, the screens in particular not displaying too much information. It would also be possible to consider adding a button on the instrument panel to select new mode of displaying optional approach paths.

The MCDU 10 can then be used to select the runway and the approach procedure that will actually be used to land the aircraft. In one elementary embodiment, for example, the pilot inputs the runway and the active approach procedure character by character on the keyboard of the MCDU immediately when notified by the approach controller. In a more advanced embodiment, the MCDU 10 could also display a list of previously selected optional runways and procedures and the pilot will then only need to select the element in the list corresponding to the active runway and the active procedure, by using only the arrow keys on the keyboard. The selected active runway and procedure are sent to the optional approach path construction function 11, that can thus determine which of the previously constructed approach paths is the active approach path.

Finally, the active approach path is sent to another function 12 of the FMS to calculate a joining path. The objective is to determine a path that will join the active approach path as soon as possible, in other words by minimizing the distance and flight time, starting from the current position of the aircraft on the route of the flight plan and before the alignment point with the runway. The joining path and the active approach path are then transmitted to a conventional function 16 of the FMS to update the flight plan, so that the flight plan can be used continuously and to retain all the resulting advantages. The objective is to insert the joining path and the active approach path at the end of the route in the flight plan. In the example embodiment in FIG. 2, the updated flight plan is sent to the MCDU 10 and the ND 15 for a simultaneous alphanumeric and graphic display. This is done by switching from the optional approach paths display mode to the existing flight plan display mode. The display of optional approach paths is then deleted from the MCDU 10 and the ND 15 and is replaced by the up-to-date flight plan.

1. A method for updating the approach path in the flight plan of an aircraft during the approach phase to a landing runway having an alignment point, comprising the steps of:
a preselection phase preselecting landing runways of the destination aerodrome having at least one approach procedure that is compatible with the performances of the aircraft and with its landing assistance equipment,
determining all approach paths corresponding to runways and procedures that were preselected,
selecting during the flight, the active runway and the active procedure,
updating during the flight, the route of the flight plan to join as soon as possible the approach path corresponding to the active runway and to the active procedure, starting from the current position of the aircraft on the route of the flight plan and before the alignment point with the runway.

2. The method for updating the approach path in the flight plan of an aircraft during the approach phase to a landing runway comprising an alignment point according to claim 1, wherein only the runways that are available on the destination airport may be selected during the preselection phase of the runways and the procedures.

3. The method for updating the approach path in the flight plan of an aircraft during the approach phase to a landing runway comprising an alignment point according to claim 1, wherein only the procedures that are in force on a selected runway may be chosen during the preselection phase of the runways and the procedures.

4. A system for updating the approach path in the flight plan of an aircraft during the approach phase to a landing runway having an alignment point, comprising the steps of:
a module to preselect landing runways of the destination aerodrome having at least one approach procedure that is compatible with the performances of the aircraft and with its landing assistance equipment;
a module to construct approach paths corresponding to the preselected runways and procedures;
a module to select the active runway and the active procedure;
a module to calculate a path for joining as soon as possible the active approach path, starting from the current position of the aircraft on the route of the flight plan and before the alignment point with the runway.

5. The system for updating the approach path in the flight plan of an aircraft during the approach phase to a landing runway comprising an alignment point according to claim 4, wherein the module to preselect the runways and the procedures only proposes the runways that are available on the destination airport.

6. The system for updating the approach path in the flight plan of an aircraft during the approach phase to a landing runway comprising an alignment point according to claim 4, wherein the module to preselect the runways and the procedures only proposes the procedures that are in force on a selected runway.

7. The system for updating the approach path in the flight plan of an aircraft during the approach phase to a landing runway comprising an alignment point according to claim 4, wherein it includes a graphic display module for displaying the approach paths.

8. The method for updating the approach path in the flight plan of an aircraft during the approach phase to a landing runway comprising an alignment point according to claim 2, wherein only the procedures that are in force on a selected runway may be chosen during the preselection phase of the runways and the procedures.

9. The system for updating the approach path in the flight plan of an aircraft during the approach phase to a landing runway comprising an alignment point according to claim 5, wherein the module to preselect the runways and the procedures only proposes the procedures that are in force on a selected runway.

10. The system for updating the approach path in the flight plan of an aircraft during the approach phase to a landing runway comprising an alignment point according to claim 5, wherein it includes a graphic display module for displaying the approach paths.

11. The system for updating the approach path in the flight plan of an aircraft during the approach phase to a landing runway comprising an alignment point according to claim 6, wherein it includes a graphic display module for displaying the approach paths.
